(19) United States
(12) Patent Application Publication
(10) Pub. No.: US 2018/0090849 A1
(43) Pub. Date: Mar. 29, 2018

(54) Extended Phase Center and Directional Gain with Modified Taper Slot Antenna for Lower Frequencies

(71) Applicant: SPAWAR Systems Center Pacific, San Diego, CA (US)

(72) Inventors: Dennis G. Bermeo, San Diego, CA (US); Peter S. Berens, San Diego, CA (US); Glenn D. Snyder, Washington, DC (US); David V. Arney, El Cajon, CA (US); Susan L. Morales, San Diego, CA (US)

(73) Assignee: United States of America as represented by Secretary of the Navy, San Diego, CA (US)

(21) Appl. No.: 15/276,307

(22) Filed: Sep. 26, 2016

(51) Int. Cl. H01Q 13/12; H01Q 1/36

(52) U.S. Cl. CPC H01Q 13/12; H01Q 1/36

(57) ABSTRACT

An antenna comprises a first antenna element, a second antenna element and a fractal element having a first fractal element end, a central fractal element length and a second fractal element end. The first antenna element, the second antenna element and the fractal element are situated in a tapered slot antenna pair configuration along a longitudinal axis. The fractal element is directly coupled to, and forms an electrical connection between, the first antenna element and the second antenna element at a location between a lowest operating frequency phase center and the launch end. The first fractal element end is coupled to the first antenna element. The second fractal element end is coupled to the second antenna element. The central fractal element length is disposed so as to be non-parallel with the longitudinal axis.

### FEDERALLY-SPONSORED RESEARCH AND DEVELOPMENT

The United States Government has ownership rights in this invention. Licensing inquiries may be directed to Office of Research and Technical Applications, Space and Naval Warfare Systems Center, Pacific, Code 72120, San Diego, Calif., 92152; telephone (619)553-5118; email: ssc_pac_t2@navy.mil. Reference Navy Case No. 102,547.

### BACKGROUND OF THE INVENTION

Embodiments of the invention relate to tapered slot antennas.

### SUMMARY OF THE INVENTION

An aspect of the present invention is drawn to an antenna comprising a first antenna element, a second antenna element and a fractal element having a first fractal element end, a central fractal element length and a second fractal element end. The first antenna element, the second antenna element and the fractal element are situated in a tapered slot antenna pair configuration along a longitudinal axis. The tapered slot antenna pair configuration comprises a launch end, and a feed end configured to be operatively coupled to an input/output feed. The fractal element is directly coupled to, and forms an electrical connection between, the first antenna element and the second antenna element at a location between a lowest operating frequency phase center and the launch end. The first fractal element end is coupled to the first antenna element. The second fractal element end is coupled to the second antenna element. The central fractal element length is disposed so as to be non-parallel with the longitudinal axis.

### BRIEF DESCRIPTION OF THE DRAWINGS

The accompanying drawings, which are incorporated in and form a part of the specification, illustrate example embodiments and, together with the description, serve to explain the principles of the invention. In the drawings:

FIG. 1 illustrates a prior art tapered slot antenna (TSA);

FIG. 2 illustrates another prior art TSA with a vertical rod;

FIG. 3 illustrates a circular formation of a plurality of TSAs;

FIG. 4 includes a graph of directivity as a function of azimuth degrees of a TSA in accordance with aspects of the present invention at 30 MHz;

FIG. 5 includes a graph of phase as a function of azimuth degrees of a TSA in accordance with aspects of the present invention at 30 MHz;

FIG. 6 includes a graph of directivity as a function of azimuth degrees of a TSA in accordance with aspects of the present invention at 44 MHz;

FIG. 7 includes a graph of phase as a function of azimuth degrees of a TSA in accordance with aspects of the present invention at 44 MHz;

FIG. 8 illustrates an example TSA in accordance with aspects of the present invention;

FIG. 9A illustrates a front view of the fractal element of the TSA of FIG. 8;

FIG. 9B illustrates a side view of the fractal element of the TSA of FIG. 8;

FIG. 9C illustrates an end view of the fractal element of the TSA of FIG. 8;

FIG. 10A illustrates a cross sectional view of the fractal element of the TSA of FIG. 9B along dotted-dashed line Y-Y;

FIG. 10B illustrates a cross sectional view of another embodiment of a fractal element in accordance with aspects of the present invention;

FIG. 10C illustrates a cross sectional view of another embodiment of a fractal element in accordance with aspects of the present invention;

FIG. 11A illustrates a cross sectional view of the fractal element of the TSA of FIG. 9B along dotted-dashed line X-X;

FIG. 11B illustrates a cross sectional view of the embodiment of a fractal element of

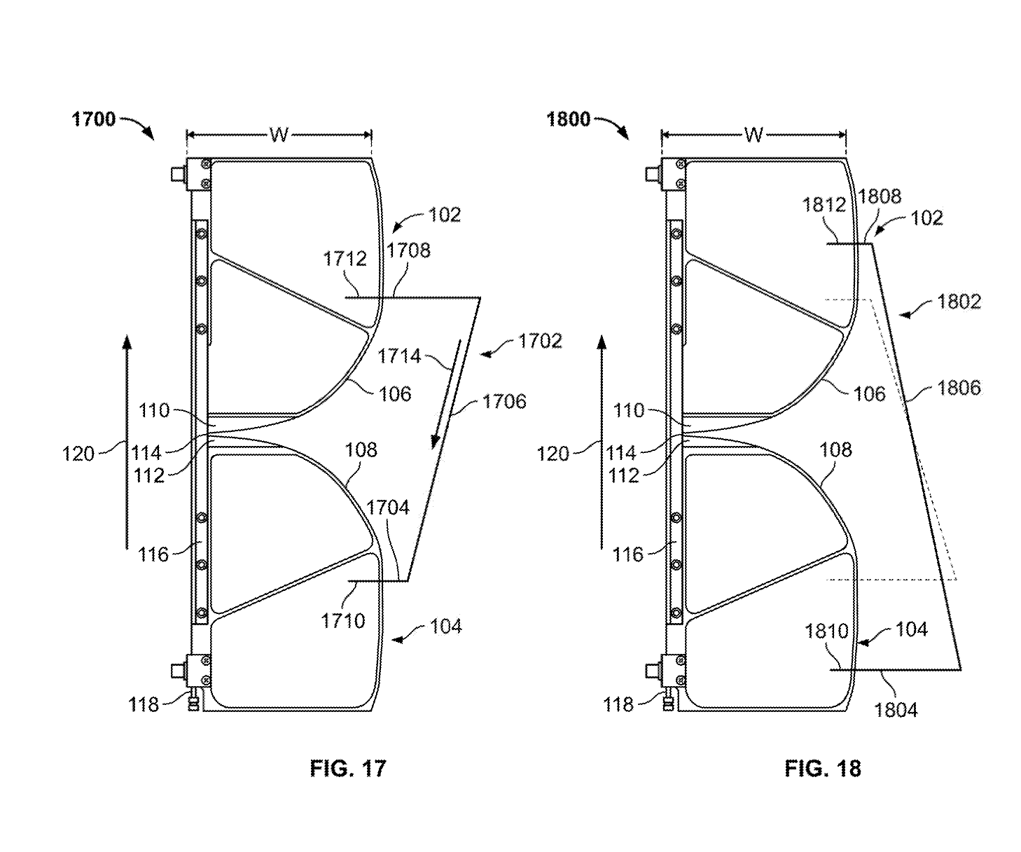

FIG. 10B at a different position along the central length;

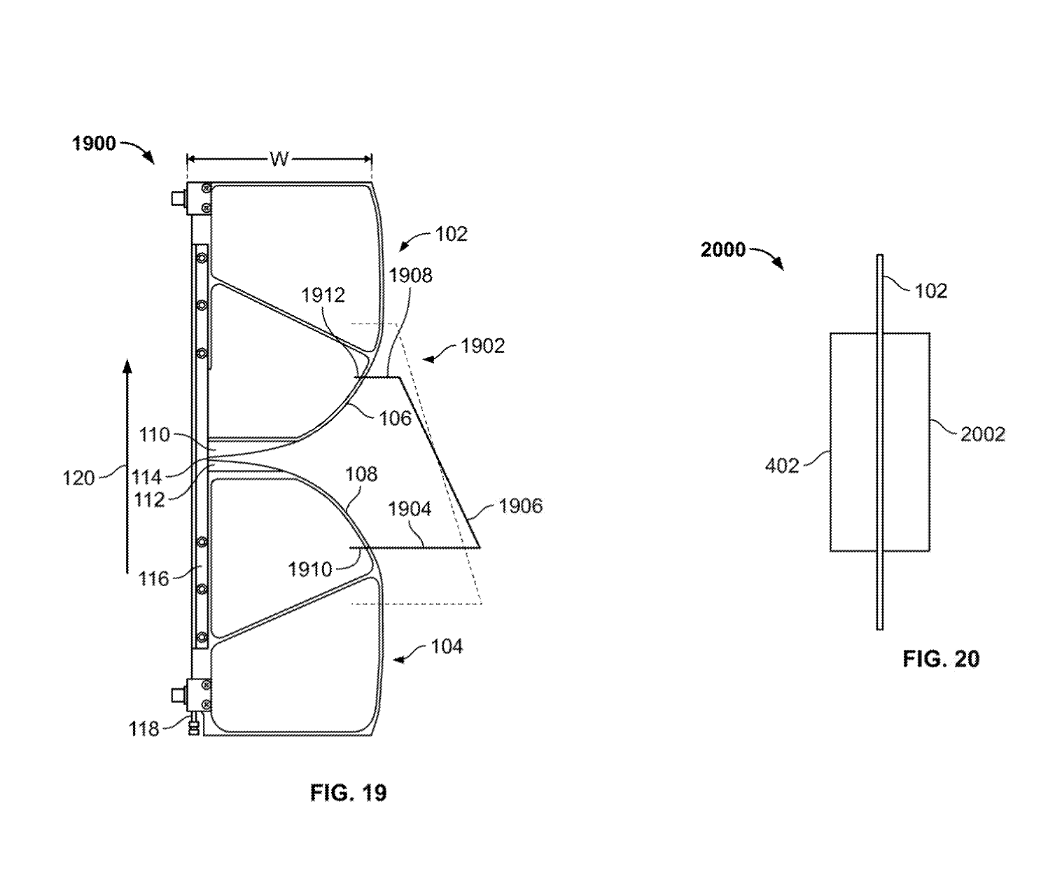

FIG. 11C illustrates a cross sectional view of the embodiment of a fractal element of

FIG. 10C at a different position along the central length;

FIG. 12A illustrates a cross sectional view of another embodiment of a fractal element in accordance with aspects of the present invention;

FIG. 12B illustrates a cross sectional view of the embodiment of a fractal element of FIG. 12A at a different position along the central length;

FIG. 13A illustrates a cross sectional view of another embodiment of a fractal element in accordance with aspects of the present invention;

FIG. 13B illustrates a cross sectional view of the embodiment of a fractal element of FIG. 13A at a different position along the central length;

FIG. 14A illustrates a cross sectional view of another embodiment of a fractal element in accordance with aspects of the present invention;

FIG. 14B illustrates a cross sectional view of the embodiment of a fractal element of FIG. 14A at a different position along the central length;

FIG. 15 illustrates another example TSA in accordance with aspects of the present invention;

FIG. 16 illustrates another example TSA in accordance with aspects of the present invention;

FIG. 17 illustrates another example TSA in accordance with aspects of the present invention;

FIG. 18 illustrates another example TSA in accordance with aspects of the present invention;

FIG. 19 illustrates another example TSA in accordance with aspects of the present invention; and

FIG. 20 illustrates another example TSA in accordance with aspects of the present invention.

### DETAILED DESCRIPTION OF THE EMBODIMENTS

The Navy uses a circular array of tapered slot antennas (TSA) for direction finding. The phase center is near the feed point of the TSA. The error in direction finding is determined by the physical distance between the phase centers. The direction of an RF signal and the physical distance between phase centers combine to determine a relative phase shift between the RF outputs of the antennas. At low frequencies the distance and phase shift is small. The low frequency performance can be improved by shifting the phase center, which is discussed in patent U.S. Pat. No. 7,397,440 B1 issued Jul. 8, 2008.

The '440 patent extends the operational frequency of the antenna below the “lowest operational frequency” or lowest theoretical cutoff frequency of the tapered slot. A conductive launch structure electrically connects two conductive elements of a TSA plays two roles: it is an active radiator and it improves the impedance match of the taper slot below theoretical cutoff frequency by introducing antiresonance into the antenna impedance.

A conductive launch structure is a structure that is capable of conducting electricity between antenna elements of an antenna pair or multiple antenna pairs of a TSA or TSA array. The structure is located along an axis between a lowest operating frequency (LOF) phase center and a launch end of a TSA. The structure extends the phase center of a TSA beyond LOF ordinary phase center (i.e., toward a launch end). The feed end is a portion of a TSA from which an input signal is received. The launch end is a portion of a TSA distal to the feed end. The lowest operating frequency is the theoretical cutoff frequency for a TSA having specific dimensions (and not having a conductive launch structure). The lowest operating frequency (LOF) phase center is the phase center for frequencies lower than the theoretical cutoff frequency for a TSA having specific dimensions regardless of having a conductive launch structure. The lowest operating frequency extended phase center is the phase center for frequencies lower than the theoretical cutoff frequency for a TSA having specific dimensions, wherein the TSA has a conductive launch structure (the conductive launch structure creates a new launch point or phase center). The lowest operating frequency ordinary phase center is the phase center for frequencies lower than the theoretical cutoff frequency for a TSA having specific dimensions, wherein the TSA does not have a conductive launch structure. The phase center is the location on a TSA representing a launch point of RF energy from the TSA relative to a feed axis. The theoretical cutoff frequency is a frequency at which an antenna's largest dimension (or antenna height) is greater than or equal to half of the respective wavelength.

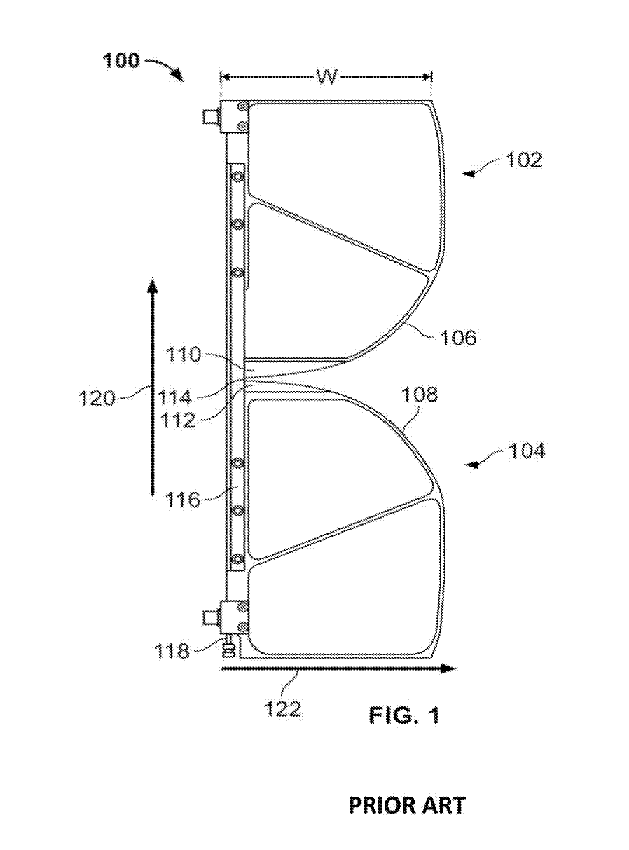

FIG. 1 illustrates a prior art TSA 100.

As shown in the figure, TSA 100 includes an antenna element 102 and an antenna element 104. Antenna elements 102 and 104 are mounted to a support 116 along a longitudinal axis 120 such that they are separated by a gap. As an example, antenna elements 102 and 104 may be fixed to support 116 using any non-conductive material. In some embodiments, the distance of the gap may be correlated to the thickness of antenna elements 102 and/or 104 to ensure properly matched impedance, as described in U.S. Pat. No. 7,701,406 to Horner et al., the entire content of which is fully incorporated by reference herein. In some embodiments, the gap may be adjusted to minimize the reflection from the antenna input.

Antenna elements 102 and 104 may comprise any conductive material that allows for reception and transmission of electromagnetic waves. As an example, antenna elements 102 and 104 may comprise aluminum, steel, copper, combinations thereof or any other conductive material. Support 116 may comprise a non-conductive material, such as fiberglass, Delrin®, or plastic. Conductive or non-conductive fasteners may be used to secure antenna elements 102 and 104 to support 116. Support 116 may be comprised of two L-shaped brackets or any other shapes so long as they physically support the structure and positioning of antenna elements 102 and 104.

A feed line 118, such as a coaxial cable, may be fed through support 116 and antenna element 102 to a feed point 114, with feed point 114 being proximate to the gap. Feed point 114 may be used to feed both antenna elements 102 and 104. A voltage applied across feed point 114 establishes a traveling electromagnetic wave that travels from a feed end near feed line 118 and along a direction indicated by arrow 122, and that launches from a launch end (furthest from feed end along the direction indicated by arrow 122) of antenna elements 102 and 104 and becomes a free propagating wave. The highest frequencies launch near feed point 114, while the lower frequencies launch at some point further away from feed point 114 along edges 110 and 112.

Feed point 114 helps provide high frequency performance and impedance match. The design of feed point 114 is driven in part by the size of feed line 118. For example, a small 0.144″ coaxial cable may be used to feed antenna elements 102 and 104.

Antenna element 102 includes a tapered width end 106 and antenna element 104 includes a tapered width end 108. As used herein, the term “tapered width end” refers to the increasing of the width W of the antenna element as a function of the increase in distance away from the feed point of the antenna element. In some embodiments, antenna elements 102 and 104 may have tapered curvatures that can be represented by the following equation:

Y(x)=a(e^{bx}−1) (Eq. 1)

where a and b are parameters that may be selectively predetermined to maximize performance of the antenna. In one embodiment, parameters a and b are approximately equal to 0.2801 and 0.1028, respectively. In some embodiments, antenna elements 102 and 104 may have a specific height to width ratio to improve directivity and gain, as described in U.S. Pat. No. 7,773,043 to Homer et al., the entire content of which is fully incorporated by reference herein.

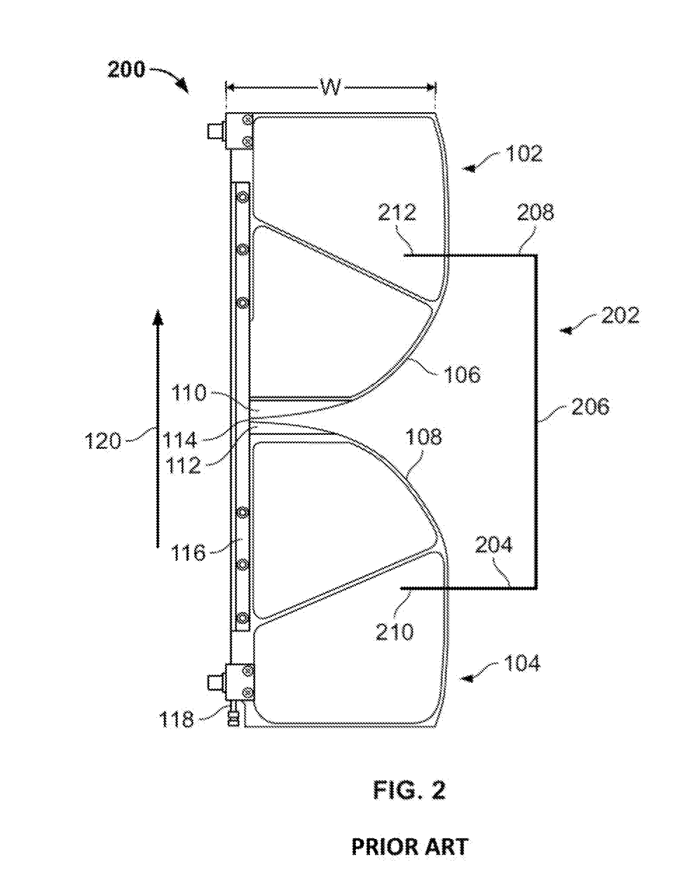

FIG. 2 illustrates another prior art TSA 200.

As shown in the figure, TSA 200 includes TSA 100 of FIG. 1, with the addition of an attached fractal element 202. Fractal element 202 includes a fractal element end 204, a central fractal element length 206 and a fractal element end 208. Fractal element 202 is connected to TSA 100 such that fractal element end 204 is electrically connected to antenna element 104 at point 210, such that fractal element end 208 is electrically connected to antenna element 102 at point 212, and such that central fractal element length 206 is parallel with longitudinal axis 120.

The tapered slot near feed point 114 is an open circuit at low frequencies DC. Above the theoretical cutoff frequency, TSA 200 will be resonant near 50 ohms. Fractal element 202 shorts TSA 200 at low frequencies (DC); at higher frequencies fractal element 202 will introduce an antiresonance or very high impedance. For frequencies between the antiresonance the antenna and the theoretical cutoff frequency, the antenna (U.S. Pat. No. 7,397,440 B1 and NC 101634) with the short will have a higher radiation resistance then the taper slot alone. The capacitance of antenna elements 102 and 104 and the inductance of fractal element 202 create a series LC circuit. This is analogous circuit for the anti-resonance, which is discussed U.S. Pat. No. 7,397,440 B1.

Fractal element 202 is naturally isolated from the tapered slot. At high frequencies the current and charge are concentrated on or very near to the slot. Only at lower frequencies will the current spread and cover a wide area an antenna element. This transition takes place below the theoretical cutoff frequency. Fractal element 202 provides a current path that shapes the charge distribution and the electric field on the slot antenna elements. The radiation from TSA 200 at low frequencies is a combination of electric field on antenna elements 102 and 104 and magnetic fields produced by fractal element 202. Fractal element 202 has properties similar to a halfloop over ground. Fractal element 202, as disclosed in U.S. Pat. No. 7,397,440 B1, is designed to match the symmetry of the tapered slot antenna elements. Fractal element 202 is onset from the tapered slot antenna to minimize interference with launch end of the antenna.

TSA 200 provides much better directivity over TSA 100. Directivity measures the power density an antenna radiates in the direction of its strongest emission (or receives, in the case of a receiving antenna, from the direction of its strongest transmitter), versus the power density radiated (or received, in the case of a receiving antenna) uniformly in all directions. Directivity is an important measure because most emissions are intended to go in a particular direction or at least in a particular plane (horizontal or vertical); emissions in other directions or planes are wasteful.

Further, TSA 200 provides much more sensitive phase detection as a result of a drastically changing phase as a function of azimuth angle. Such a sensitive phase detection, in conjunction with an increased directivity ensures that TSA 200 is better able to direct an emission (or detect the direction from a transmission source in the case of a receiving antenna).

In particular, the addition of fractal element 202 modifies the electromagnetic characteristics of the TSA so that, as a transmitting antenna, TSA 200 can transmit greater power towards a predetermined angular direction, and as a receiving antenna, TSA 200 can receive signals at greater efficiency from a predetermined angular direction.

By coupling a plurality of TSAs, as a receiving antenna, the direction of a transmitted signal can be accurately determined.

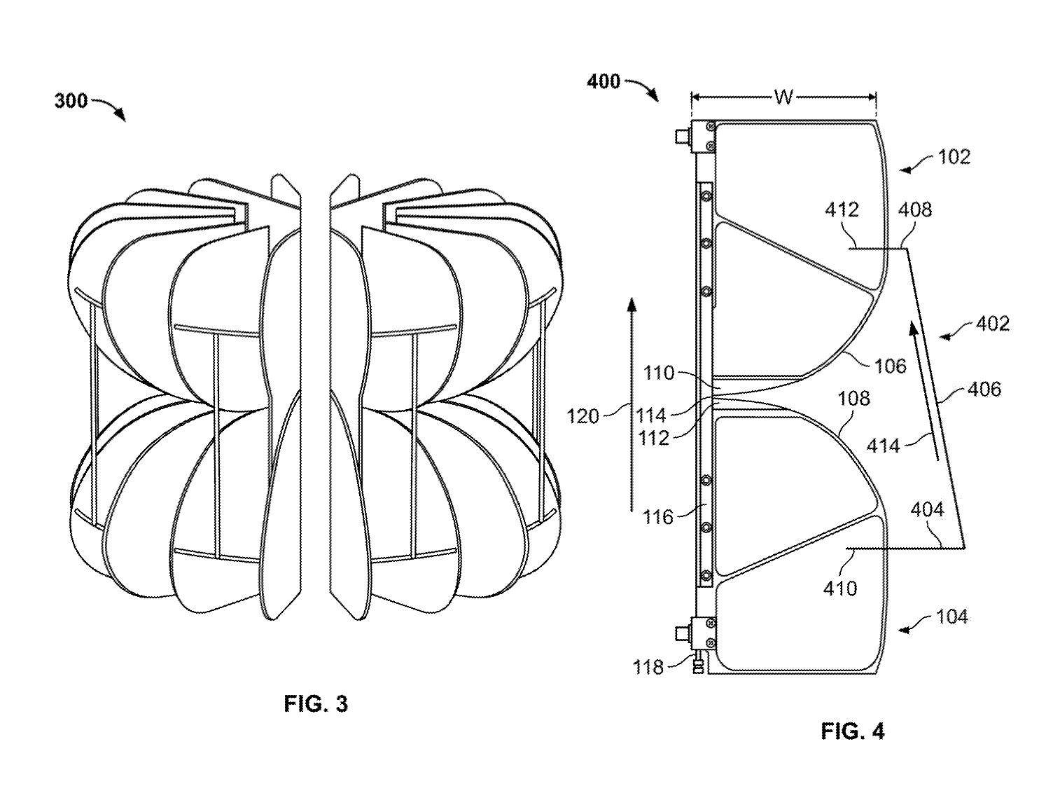

FIG. 3 illustrates a circular formation 300 of a plurality of TSAs.

Circular formation 300 includes a plurality of TSAs, such as TSA 200, each of which includes a fractal element. The fractal elements enable circular formation 300 to more accurately determine the direction from which a received signal has originated.

A goal of the present invention is to move the phase center away from the antenna feed point and increase the forward gain (decrease the reverse gain). A fractal element that is not parallel with the axis of the feed line connects the top and bottom of the tapered slot antenna. This fractal element is not vertical and extends out in front of the tapered slot. The prior art TSA, for example as discussed above with reference to FIG. 2, uses a vertical rod connected top and bottom of the tapered slot antenna elements with a rod perpendicular to the fractal element.

After performing extensive numerical simulation, a complex design in accordance with aspects of the present invention. Changing the angle of the fractal element allows the pattern of the electrically small loop (37 cm loop wire length<<λ=10 m) to overlap with the TSA dipole pattern. The placement on the fractal device on the TSA introduces the phase shift required to obtain forward constructive and backward destructive interference. It is understood that many variations are possible some could perform better or similar.

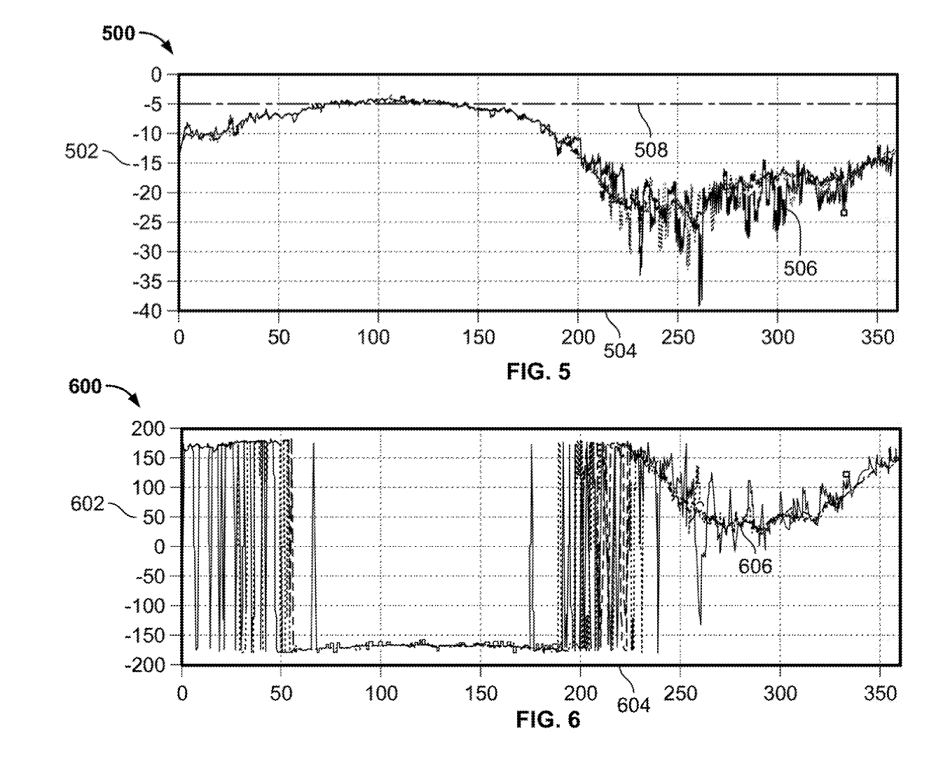

Aspects of the present invention will now be further described with reference to FIGS. 4-20.

FIG. 4 illustrates an example TSA 400 in accordance with aspects of the present invention.

As shown in the figure, TSA 400 includes TSA 100 of FIG. 1, with the addition of an attached fractal element 402. Fractal element 402 includes a fractal element end 404, a central fractal element length 406 and a fractal element end 408. Fractal element 402 is connected to TSA 100 such that fractal element end 404 is electrically connected to antenna element 104 at point 410, such that fractal element end 408 is electrically connected to antenna element 102 at point 412, and such that feed point 114 is symmetrically disposed between point 412 and point 410.

Fractal element end 408 is shorter than fractal element end 404 such that central fractal element length 606 is non-parallel with axis 120 as shown by arrow 412. By having a non-parallel (with axis 120) central fractal element length, the directivity increases and the phase sensitivity increases.

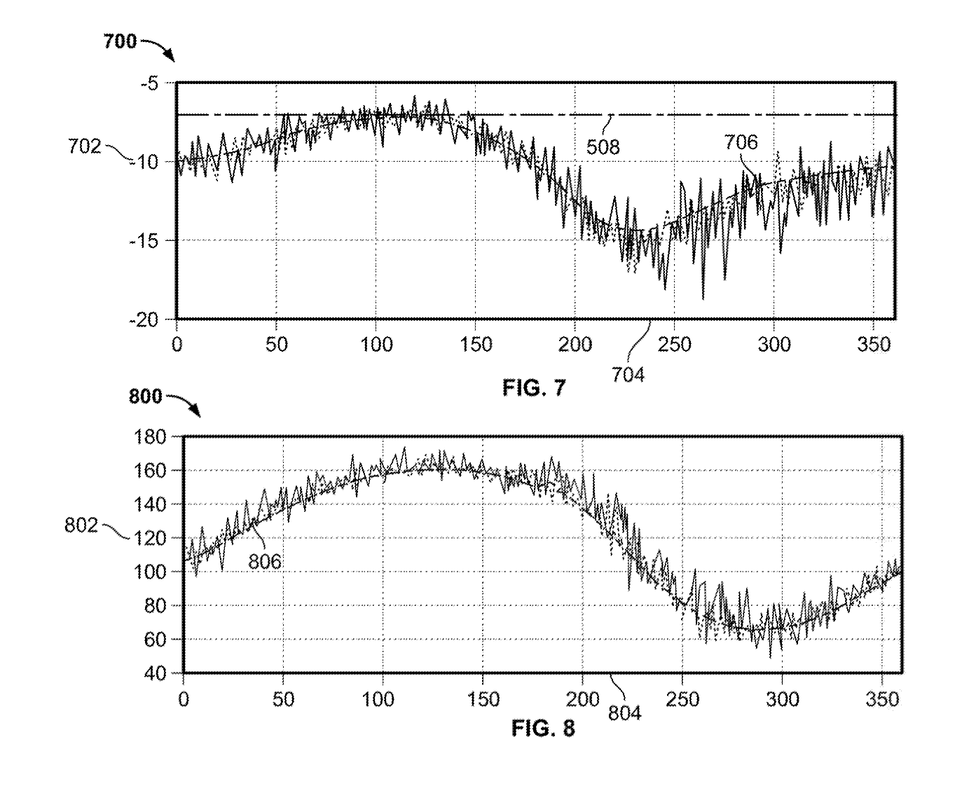

The primary advantage is the shift of the phase center of the antenna. The second advantage is the improved gain in the forward directions at low frequencies. A prior art TSA without a fractal element would normally have a dipole pattern. Creating forward gain is a very important result. A fractal element in accordance with aspects of the present invention increases the impedance to match 50 ohms at low frequencies. The combination of antenna gain and phase center allowed a direction finding algorithm to have an error 4 degrees or less above 30 MHz. This will be further described with reference to FIGS. 5-8.

FIG. 5 includes a graph 500 of directivity as a function of azimuth degrees of a TSA in accordance with aspects of the present invention at 30 MHz.

As shown in the figure, graph 500 includes a Y-axis 502 of directivity in dBi, an X-axis 504 of azimuth in degrees, a function 506 and a dashed-dotted line 508.

As a frame of reference, a monopole antenna may have a constant directivity as a function of azimuth angle as represented by dashed-dotted line 508. In other words, a monopole antenna would radiate uniformly in all directions. On the contrary, a TSA having a fractal element in accordance with aspects of the present invention has more directivity from about 50°-175° and a minimum directivity from about 200°-300°, as shown by function 506.

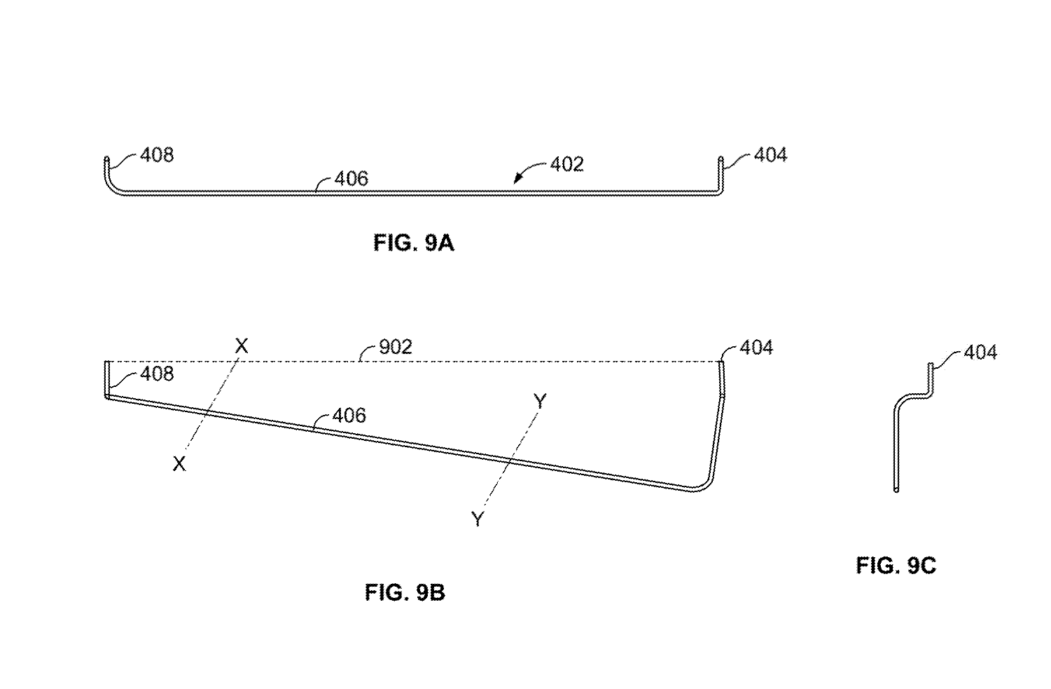

FIG. 6 includes a graph 600 of phase as a function of azimuth degrees of a TSA in accordance with aspects of the present invention at 30 MHz.

As shown in the figure, graph 600 includes a Y-axis 602 of phase in degrees, an X-axis 604 of azimuth in degrees, and a function 606. As shown in the figure, the phase is generally constant from approximately 75°-180°. Otherwise, there are drastic phase changes over very small changes in azimuth. Phase changes further improve the direction finding accuracy.

A TSA in accordance with aspects of the present invention provides an increased directivity, as evidenced by graph 500 of FIG. 5, and an increased sensitivity in phase changes, as evidenced by graph 600 of FIG. 6. Accordingly, a circular formation of a plurality of TSAs in accordance with aspects of the present invention that operates in a fashion similar to circular formation 300 of FIG. 3, but with increased directivity and phase sensitivity, would provide a much more accurate determination of a source direction.

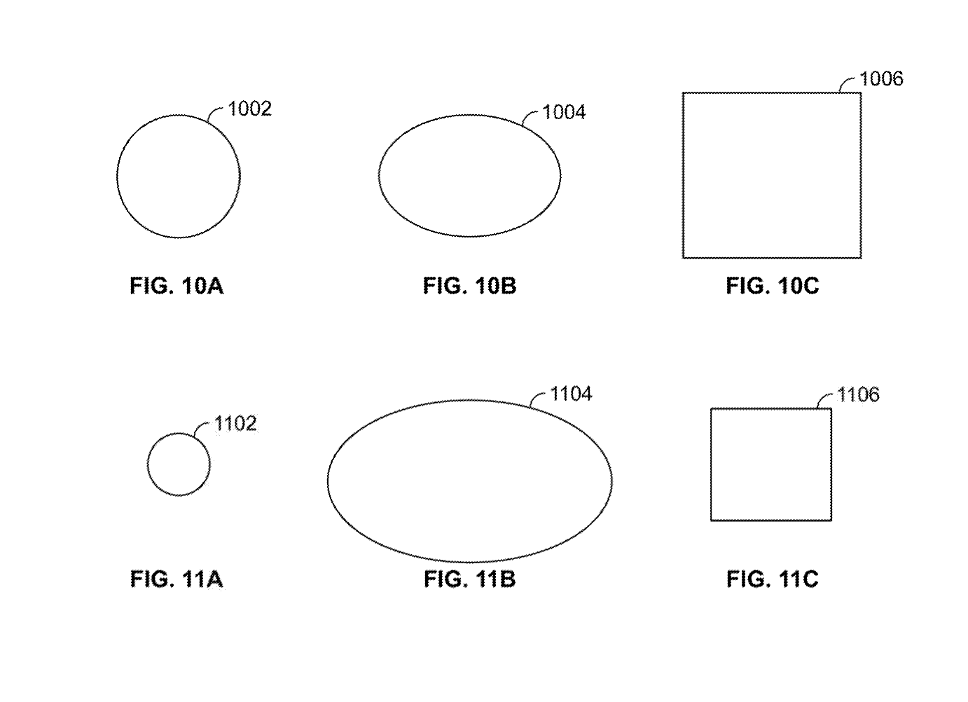

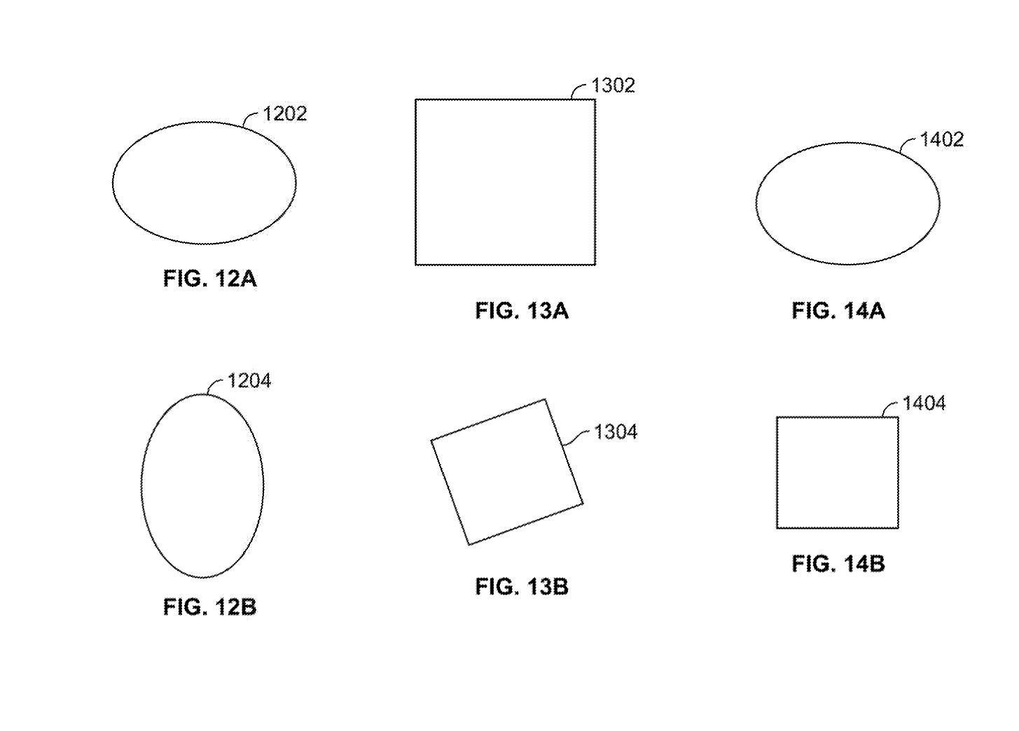

Another example of increased directivity and phase sensitivity of a TSA in accordance with aspects of the present invention will now be described with reference to FIGS. 7-8.

FIG. 7 includes a graph 700 of directivity as a function of azimuth degrees of a TSA in accordance with aspects of the present invention at 44 MHz.

As shown in the figure, graph 700 includes a Y-axis 702 of directivity in dBi, an X-axis 704 of azimuth in degrees, and a function 706.

Again, as a frame of reference, a monopole antenna may have a constant directivity as a function of azimuth angle as represented by dashed-dotted line 508. TSA having a fractal element in accordance with aspects of the present invention has more directivity from about 75°-150° and a minimum directivity from about 200°-300°, as shown by function 706.

FIG. 8 includes a graph 800 of phase as a function of azimuth degrees of a TSA in accordance with aspects of the present invention at 44 MHz.

As shown in the figure, graph 800 includes a Y-axis 802 of phase in degrees, an X-axis 804 of azimuth in degrees, and a function 806. FIG. 8 shows the phase change over azimuth at a different frequency. FIGS. 5-8 show that a fractal element in accordance with aspects of the present invention is effective over different frequency ranges.

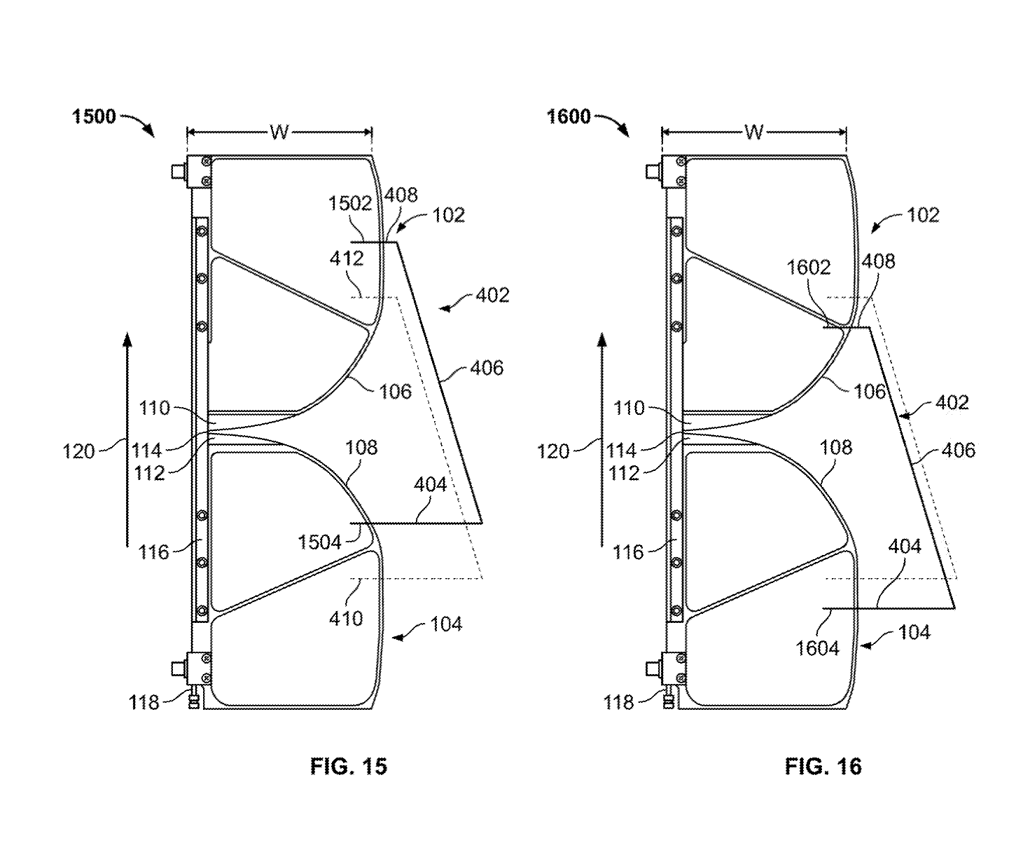

FIG. 9A illustrates a front view of fractal element 402 of TSA 400 of FIG. 4. FIG. 9B illustrates a side view of fractal element 402. FIG. 9C illustrates an end view of fractal element 402.

As shown in FIG. 9B, fractal element end 404 is a different length than fractal element end 408. In this non-limiting example embodiment, fractal element end 404 is longer than fractal element end 408. As a result of the different lengths of fractal element end 404 and fractal element end 408, central fractal element length 406 is disposed an angle relative to an axis between the end points of fractal element end 404 and fractal element end 408 as indicated by dotted line 902.

The angled disposition of central fractal element length 406 modifies the directivity and phase sensitivity of TSA 400. The directivity and phase sensitivity may be further modified by modifying the shape, size, location and disposition of a fractal element in accordance with aspects of the present invention.

FIG. 10A illustrates a cross sectional view of fractal element 402 of TSA 400 of FIG. 9B along dotted-dashed line Y-Y. As shown in FIG. 10A, fractal element 402 has a circular cross section 1002 at dotted-dashed line Y-Y.

FIG. 10B illustrates a cross sectional view of another non-limiting example embodiment of a fractal element, at a similar location to that of dotted-dashed line Y-Y of FIG. 10A, in accordance with aspects of the present invention. As shown in FIG. 10B, this fractal element has a non-circular cross section. More particularly, this fractal element has an elliptical cross section 1004 at a similar location to that of dotted-dashed line Y-Y of FIG. 10A.

FIG. 10C illustrates a cross sectional view of yet another non-limiting example embodiment of a fractal element, at a similar location to that of dotted-dashed line Y-Y of FIG. 10A, in accordance with aspects of the present invention. As shown in FIG. 10C, this fractal element has another non-circular cross section. More particularly, this fractal element has a square cross section 1006 at a similar location to that of dotted-dashed line Y-Y of FIG. 10A.

In accordance with aspects of the present invention, the cross-sectional area of a fractal element may vary as a function of distance. This will be described with further reference to FIGS. 11A-11C.

FIG. 11A illustrates a cross sectional view of fractal element 402 of TSA 400 of FIG. 10A along dotted-dashed line X-X. As shown in FIG. 11A, fractal element 402 has a circular cross section 1102 at dotted-dashed line X-X. As compared to circular cross section 1002 of FIG. 10A, circular cross section 1102 is much smaller. This is a result of the circular cross section of central fractal element length 406 decreasing in size as a function of length from fractal element end 404 to fractal element end 408.

FIG. 11B illustrates a cross sectional view of the embodiment of the fractal element of FIG. 10B at a different position along the central length. As shown in FIG. 11B, this fractal element has an elliptical cross section 1104. As compared to circular cross section 1004 of FIG. 10B, circular cross section 1104 is much larger. This is a result of the elliptical cross section of the central fractal element length increasing in size as a function of length from one fractal element end (corresponding to fractal element end 404 of fractal element 402) to the other fractal element end (corresponding to fractal element end 408 of fractal element 402).

FIG. 11C illustrates a cross sectional view of the embodiment of the fractal element of FIG. 10C at a different position along the central length. As shown in FIG. 11C, this fractal element has a square cross section 1106. As compared to square cross section 1006 of FIG. 10C, square cross section 1106 is much smaller. This is a result of the square cross section of the central fractal element length decreasing in size as a function of length from one fractal element end (corresponding to fractal element end 404 of fractal element 402) to the other fractal element end (corresponding to fractal element end 408 of fractal element 402).

It should be noted that the above-discussed shapes of FIGS. 10A-11C are non-limiting example embodiment provided for purposed of discussion. Any shape may be used in accordance with aspects of the present invention.

In accordance with aspects of the present invention, the cross-sectional shape of a fractal element may vary as a function of distance. This will be described with further reference to FIGS. 12A-14C.

FIG. 12A illustrates a cross sectional view of another non-limiting example embodiment of a fractal element, at a similar location to that of dotted-dashed line Y-Y of FIG. 10A, in accordance with aspects of the present invention. As shown in FIG. 12A, this fractal element has a non-circular cross section. More particularly, this fractal element has an elliptical cross section 1202 at a similar location to that of dotted-dashed line Y-Y of FIG. 10A.

FIG. 12B illustrates a cross sectional view of the embodiment of the fractal element of FIG. 12A at a different position along the central length.

As shown in FIG. 12B, this fractal element has an elliptical cross section 1204. As compared to elliptical cross section 1202 of FIG. 12A, elliptical cross section 1204 is the same size, but is rotated by 90°. This is a result of the elliptical cross section of the central fractal element length rotating its major axis as a function of length from one fractal element end (corresponding to fractal element end 404 of fractal element 402) to the other fractal element end (corresponding to fractal element end 408 of fractal element 402).

FIG. 13A illustrates a cross sectional view of another non-limiting example embodiment of a fractal element, at a similar location to that of dotted-dashed line Y-Y of FIG. 10A, in accordance with aspects of the present invention. As shown in FIG. 13A, this fractal element has a non-circular cross section. More particularly, this fractal element has a square cross section 1302 at a similar location to that of dotted-dashed line Y-Y of FIG. 10A.

FIG. 13B illustrates a cross sectional view of the embodiment of a fractal element of FIG. 13A at a different position along the central length.

As shown in FIG. 13B, this fractal element has a square cross section 1304. As compared to square cross section 1302 of FIG. 13A, square cross section 1304 is smaller in size, and is rotated. This is a result of the cross section of the central fractal element length decreasing in size and rotating as a function of length from one fractal element end (corresponding to fractal element end 404 of fractal element 402) to the other fractal element end (corresponding to fractal element end 408 of fractal element 402).

FIG. 14A illustrates a cross sectional view of another non-limiting example embodiment of a fractal element, at a similar location to that of dotted-dashed line Y-Y of FIG. 10A, in accordance with aspects of the present invention. As shown in FIG. 14A, this fractal element has a non-circular cross section. More particularly, this fractal element has an elliptical cross section 1402 at a similar location to that of dotted-dashed line Y-Y of FIG. 10A.

FIG. 14B illustrates a cross sectional view of the embodiment of a fractal element of FIG. 14A at a different position along the central length.

As shown in FIG. 14B, this fractal element has a square cross section 1404. As compared to elliptical cross section 1402 of FIG. 14A. This is a result of the cross section of the central fractal element length changing in shape as a function of length from one fractal element end (corresponding to fractal element end 404 of fractal element 402) to the other fractal element end (corresponding to fractal element end 408 of fractal element 402).

The non-limiting example embodiments discussed above with reference to FIGS. 10A-14B illustrate different shapes and sizes of a fractal element in accordance with aspects of the present invention. However, as note previously, the directivity and phase sensitivity may be further modified by modifying the location and disposition of a fractal element.

FIG. 15 illustrates another example TSA 1500 in accordance with aspects of the present invention.

As shown in the figure, TSA 1500 is similar to TSA 400 of FIG. 4, with the exception of attached fractal element 402 be shifted from a position indicated by the dotted line and away from feed line 118 in a direction parallel to axis 120. Fractal element 402 is connected such that fractal element end 404 is electrically connected to antenna element 104 at point 1504 (as opposed to point 410 as in TSA 400), such that fractal element end 408 is electrically connected to antenna element 102 at point 1502 (as opposed to point 412 as in TSA 400), and such that feed point 114 is asymmetrically disposed between point 1502 and point 1504. In this embodiment, the distance between fractal element end 408 and feed point 114 is greater than the distance between fractal element end 404 and feed point 114.

FIG. 16 illustrates another example TSA 1600 in accordance with aspects of the present invention.

As shown in the figure, TSA 1600 is similar to TSA 400 of FIG. 1, with the exception of attached fractal element 402 be shifted from a position indicated by the dotted line and toward from feed line 118 in a direction parallel to axis 120. Fractal element 402 is connected such that fractal element end 404 is electrically connected to antenna element 104 at point 1604 (as opposed to point 410 as in TSA 400), such that fractal element end 408 is electrically connected to antenna element 102 at point 1602 (as opposed to point 412 as in TSA 400), and such that feed point 114 is asymmetrically disposed between point 1602 and point 1604. In this embodiment, the distance between fractal element end 408 and feed point 114 is less than the distance between fractal element end 404 and feed point 114.

In the above-discussed, non-limiting example embodiments, the fractal element is disposed such that the shorter of the two fractal element ends, e.g., fractal element end 408, is farther away from feed line 118 than the longer of the two fractal element ends, e.g., fractal element end 404. However, in some embodiments, the disposition of the fractal element may be opposite.

FIG. 17 illustrates another example TSA 1700 in accordance with aspects of the present invention.

As shown in the figure, TSA 1700 includes TSA 100 of FIG. 1, with the addition of an attached fractal element 1702. Fractal element 1702 includes a fractal element end 1704, a central fractal element length 1706 and a fractal element end 1708. Fractal element 1702 is connected to TSA 100 such that fractal element end 1704 is electrically connected to antenna element 104 at point 1710, such that fractal element end 1708 is electrically connected to antenna element 102 at point 1712, and such that feed point 114 is symmetrically disposed between point 412 and point 410.

Fractal element end 1708 is longer than fractal element end 1704 such that central fractal element length 606 is non-parallel with axis 120 as shown by arrow 1714. In this embodiment, fractal element 1702 is disposed such that the longer of the two fractal element ends, i.e., fractal element end 1708, is farther away from feed line 118 than the shorter of the two fractal element ends, i.e., fractal element end 1704.

In the above-discussed, non-limiting example embodiments, the distance between the connection points of the fractal element and the antenna elements, e.g., the distance between point 412 and point 410 of TSA 400 of FIG. 4, or the distance between point 1602 and 1604 of TSA 1600 of FIG. 16. However, other embodiments have different distances between the connection points of the fractal element and the antenna elements.

FIG. 18 illustrates another example TSA 1800 in accordance with aspects of the present invention.

As shown in the figure, TSA 1800 includes TSA 100 of FIG. 1, with the addition of an attached fractal element 1802. Fractal element 1802 includes a fractal element end 1804, a central fractal element length 1806 and a fractal element end 1808. Fractal element 1802 is connected to TSA 100 such that fractal element end 1804 is electrically connected to antenna element 104 at point 1810, such that fractal element end 1808 is electrically connected to antenna element 102 at point 1812, and such that feed point 114 is symmetrically disposed between point 1812 and point 1810.

Fractal element 1802 is larger than fractal element 402 such the distance between point 1812 and point 1810 is greater than the distance between point 412 and point 410 of TSA 400 of FIG. 4. In other embodiments, the distance between mounting points may be shorter.

FIG. 19 illustrates another example TSA 1900 in accordance with aspects of the present invention.

As shown in the figure, TSA 1900 includes TSA 100 of FIG. 1, with the addition of an attached fractal element 1902. Fractal element 1902 includes a fractal element end 1904, a central fractal element length 1906 and a fractal element end 1908. Fractal element 1902 is connected to TSA 100 such that fractal element end 1904 is electrically connected to antenna element 104 at point 1910, such that fractal element end 1908 is electrically connected to antenna element 102 at point 1912, and such that feed point 114 is symmetrically disposed between point 1912 and point 1910.

Fractal element 1902 is shorter than fractal element 402 such the distance between point 1912 and point 1910 is less than the distance between point 412 and point 410 of TSA 400 of FIG. 4.

In the above-discussed, non-limiting example embodiments, a single fractal element is connected to antenna element 102 and antenna element 104. However, in some embodiments, an additional fractal element may be attached to antenna element 102 and antenna element 104.

FIG. 20 illustrates another example TSA 2000 in accordance with aspects of the present invention.

As shown in the figure, TSA 2000 includes TSA 400 of FIG. 4, with the addition of an attached fractal element 2002. Fractal element 2002 is similar to fractal element 402, but is disposed on the opposite sides of antenna elements 102 and 104. The addition of fractal element 2002 further modifies the directivity and phase sensitivity of TSA 2000.

In summary, the present invention modifies the shape, size, placement and disposition of the fractal device on the TSA introduces the phase shift required to obtain forward constructive and backward destructive interference.

The foregoing description of various preferred embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. An antenna comprising:
a first antenna element capable of transmitting and receiving radio frequency energy;
a second antenna element capable of transmitting and receiving radio frequency energy; and
a fractal element having a first fractal element end, a central fractal element length and a second fractal element end,
wherein said first antenna element, said second antenna element and said fractal element are situated in a tapered slot antenna pair configuration along a longitudinal axis,
wherein the tapered slot antenna pair configuration comprises a launch end, and a feed end configured to be operatively coupled to an input/output feed,
wherein said fractal element is directly coupled to, and forms an electrical connection between, said first antenna element and said second antenna element at a location between a lowest operating frequency phase center and said launch end,
wherein said first fractal element end is coupled to said first antenna element,
wherein said second fractal element end is coupled to said second antenna element, and
wherein said central fractal element length is disposed so as to be non-parallel with the longitudinal axis.

2. The antenna of claim 1, wherein said central fractal element length has a circular cross-sectional shape.

3. The antenna of claim 2, wherein said central fractal element length has a cross-sectional shape that changes as a function of distance.

4. The antenna of claim 3, wherein said central fractal element length is centrally disposed between said first antenna element and said second antenna element.

5. The antenna of claim 1, wherein said central fractal element length has a noncircular cross-sectional shape.

6. The antenna of claim 5, wherein said central fractal element length has cross-sectional shape that changes as a function of distance.

7. The antenna of claim 6, wherein said central fractal element length is centrally disposed between said first antenna element and said second antenna element.

8. The antenna of claim 1, wherein said central fractal element length has cross-sectional shape that changes as a function of distance.

9. The antenna of claim 8, wherein said central fractal element length is centrally disposed between said first antenna element and said second antenna element.

10. The antenna of claim 1, wherein said central fractal element length is centrally disposed between said first antenna element and said second antenna element.

11. An antenna comprising:
a first antenna element capable of transmitting and receiving radio frequency energy;
a second antenna element capable of transmitting and receiving radio frequency energy;
a first fractal element having a first fractal element end, a central fractal element length and a second fractal element end; and
a second fractal element,
wherein said first antenna element, said second antenna element, said first fractal element and said second fractal element are situated in a tapered slot antenna pair configuration along a longitudinal axis,
wherein the tapered slot antenna pair configuration comprises a launch end, and a feed end configured to be operatively coupled to an input/output feed,
wherein said first fractal element is directly coupled to, and forms an electrical connection between, said first antenna element and said second antenna element at a location between a lowest operating frequency phase center and said launch end,
wherein said second fractal element is directly coupled to, and forms an electrical connection between, said first antenna element and said second antenna element at the location between a lowest operating frequency phase center and said launch end,
wherein said first fractal element end is coupled to said first antenna element,
wherein said second fractal element end is coupled to said second antenna element, and
wherein said central fractal element length is disposed so as to be non-parallel with the longitudinal axis.

12. The antenna of claim 11, wherein said central fractal element length has a circular cross-sectional shape.

13. The antenna of claim 12, wherein said central fractal element length has a cross-sectional shape that changes as a function of distance.

14. The antenna of claim 13, wherein said central fractal element length is centrally disposed between said first antenna element and said second antenna element.

15. The antenna of claim 11, wherein said central fractal element length has a noncircular cross-sectional shape.

16. The antenna of claim 15, wherein said central fractal element length has cross-sectional shape that changes as a function of distance.

17. The antenna of claim 16, wherein said central fractal element length is centrally disposed between said first antenna element and said second antenna element.

18. The antenna of claim 11, wherein said central fractal element length has cross-sectional shape that changes as a function of distance.

19. The antenna of claim 18, wherein said central fractal element length is centrally disposed between said first antenna element and said second antenna element.

20. A method of transmitting comprising:
generating a transmission signal;
providing the transmission signal to an antenna including:
a first antenna element capable of transmitting and receiving radio frequency energy;
a second antenna element capable of transmitting and receiving radio frequency energy;
a first fractal element having a first fractal element end, a central fractal element length and a second fractal element end; and
a second fractal element,
wherein the first antenna element, the second antenna element, the first fractal element and the second fractal element are situated in a tapered slot antenna pair configuration along a longitudinal axis,
wherein the tapered slot antenna pair configuration comprises a launch end, and a feed end configured to be operatively coupled to an input/output feed,
wherein the first fractal element is directly coupled to, and forms an electrical connection between, the first antenna element and the second antenna element at a location between a lowest operating frequency phase center and the launch end,
wherein the second fractal element is directly coupled to, and forms an electrical connection between, the first antenna element and the second antenna element at the location between a lowest operating frequency phase center and the launch end,
wherein the first fractal element end is coupled to the first antenna element,
wherein the second fractal element end is coupled to the second antenna element, and
wherein the central fractal element length is disposed so as to be non-parallel with the longitudinal axis, and
transmitting an electromagnetic signal, based on the transmission signal, from the antenna.
